(19) United States
(12) Patent Application Publication
(10) Pub. No.: US 2023/0189759 A1
(43) Pub. Date: Jun. 22, 2023

(54) Reusable Cloth System

(71) Applicant: Vita Florio, Herndon, VA (US)

(72) Inventor: Vita Florio, Herndon, VA (US)

(21) Appl. No.: 17/933,211

(22) Filed: Sep. 19, 2022

Related U.S. Application Data
(60) Provisional application No. 63/291,972, filed on Dec. 21, 2021.

(51) Int. Cl. A01K 13/00

(52) U.S. Cl. CPC A01K 13/006

(57) ABSTRACT

The present invention relates to a cloth bib system for performing grooming activities such as wiping excess saliva from the mouth of a dog. The bib system is configured to be removably secured to a pet accessory, such as a dog collar. The bib system features a pair of folded cloths secured to a collar using one or more clips. To perform the grooming operation, one of the bibs is unfolded and used for cleaning. The other bib can be used in a similar manner thereby maintaining hygiene and cleanliness. The bibs are machine washable and can be in various sizes and designs enabling pet owners to accessorize their pets with several different colors and styles.

### CROSS-REFERENCE TO RELATED APPLICATION

The present application claims priority to, and the benefit of, U.S. Provisional Application No. 63/291,972, which was filed on December 21^{st}, 2021, and is incorporated herein by reference in its entirety.

### FIELD OF THE INVENTION

The present invention relates generally to the field of pet accessories. More specifically, the present invention relates to a novel cloth bib system for dogs and other pets. The bib system is secured to a pet collar or harness and provides an accessory when not being used for wiping away excess drool and saliva from a pet's mouth or wiping down a pet coming in from a rain or from other spills. The bib system has one or more folded cloth bibs secured to a collar, harness, leashes, belts, or other accessories which may be used for managing pets by using carabiner clips. In use, one of the bibs may be unfolded and used for wiping away saliva, food, wetness or simply for grooming purposes. The bibs are machine washable and can be produced in various sizes, patterns, configurations and designs. Accordingly, the present disclosure makes specific reference thereto. Nonetheless, it is to be appreciated that aspects of the present invention are also equally applicable to other like applications, devices, and methods of manufacture.

### BACKGROUND

By way of background, pets drool occasionally, and certain breeds drool excessively due to the presence of jowls or other flaps or folds around the mouth of the pet. Drool or ptyalism, is an excessive flow of saliva that has accumulated in the mouth/oral cavity. Drooling is very common in breeds such as Saint Bernard, Dogue de Bordeaux, Bloodhound, Bulldog, Newfoundland, Neapolitan Mastiff, Bernese Mountain Dog and others. Even pets such as dogs that don't slobber or drool all the time can drip a bit of drool when they anticipate something delicious.

Slobbering can be caused by a variety of issues. Stomach distress, toxic substances, carsickness, heat stroke, infections and more can cause drooling. Liver diseases, kidney diseases and more can also cause drooling. Oral diseases like tooth decay, gum inflammation, tartar buildup, and oral tumors in the mouth and/or throat can cause dogs to drool more than normal. However, sometimes, even without an issue or disease, dogs drool and may slobber excessively.

Excessive drool by pets such as dogs, can be slimy and gross and people, including the pet or dog owner or caretaker, may be disgusted and annoyed by excessive drooling. In many public places like malls, shopping centers, restaurants and more, pets are welcomed but excessive drooling can be unpleasing and unappetizing for people.

Generally, pet owners use wipes or clothes for wiping up their dog's saliva, cleaning around the pet's mouth, and for general grooming purposes. Reusing wipes or clothes without regular washing is unsafe for pets and may cause infection due to the buildup of bacteria and germs. Further, wipes or clothes may not always be available when needed and also create waste when thrown away. Therefore, pet owners and caretakers desire bibs that can be easily and safely used to clean excess drool from their dog's mouth and for general grooming and cleaning of the pet. People desire bibs and cleaning clothes that can be attached to a collar, harness, leash, or other pet accessory thereby eliminating the need for pet owners to remember to carry wipes or bibs.

Therefore, there exists a long-felt need in the art for a lightweight fabric or other material to create a bib for pets, such as dogs, which can be easily used for cleaning and drying excess drool from a pet's mouth as well as to perform other grooming needs. There is also a long-felt need in the art for a pet bib that can be firmly secured to an accessory used with the pet, such as a collar or harness. Additionally, there is a long-felt need in the art for fabric or other material bib for dogs that can be washed and dried in conventional laundry machines for reuse. Moreover, there is a long-felt need in the art for pet bibs that are safe and convenient to use. Further, there is a long-felt need in the art for fabric bibs that maintain cleanliness and hygiene of the pets. Furthermore, there is a long-felt need in the art for a fabric bib that can function as an accessory for pets when not in use. Finally, there is a long-felt need in the art for lightweight cloth bib for pets that can be used for wiping excess drool and saliva and is secured to an accessory for the pet, such as collar, harness, leash, strap or another item used with a pet.

The subject matter disclosed and claimed herein, in one embodiment thereof, comprises a bib system for grooming, such as wiping away excess saliva from the mouth of a pet. The bib system has one or more washable bibs and enables pet owners to accessorize their pets with several different colors, patterns, and styles of the bibs. The bib system further includes at least one individual cloth bib, with each bib in one embodiment being generally rectangular in shape and having a pair of longitudinal sides and a pair of lateral or transverse sides. Each bib has a bib design and a hole near a top lateral edge, a carabiner clip for each bib and the carabiner clip is configured to pass through the hole in the bib for securing the bib to a collar or other accessory. A clip is provided for each bib to secure the bib in a folded position, and when the clip of a bib is removed, the bib is unfolded and can be used for grooming, cleaning or another task such as wiping away excess drool and saliva from a dog's mouth.

In this manner, the reusable cloth bib of the present invention accomplishes all of the foregoing objectives and provides pet owners and caretakers with lightweight fabric bibs designed to clean and dry excess drool from a pet's mouth. Having two or more bibs available allows users to groom, such as wiping up drool over a prolonged period of time. The bibs are secured to collar or other pet accessory when not used and can be easily unfolded for wiping and removing drool or other grooming activity. The bibs are configured to be easily removable from the collar or other pet accessory and can be easily replaced or washed for reuse.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bib or towel system for grooming activities, such as wiping away excess saliva from a pet's or dog's mouth. The bib or towel system further includes a pair of individual cloth bibs or towels, and each bib, in one embodiment, is generally rectangular in shape and has a pair of longitudinal sides and a pair of lateral or transverse sides. Each bib or towel has a design or other indicia and a hole near a top lateral or transverse edge. A first clip, such as a carabiner clip, is provided with each bib or towel, and the carabiner clip is configured to pass through the hole of the bib or for securing the bib or towel to a collar, harness, leash, lead, strap or other pet accessory. A second clip, such as a paper or binder clip, is provided with each bib or towel to secure the bib or towel in a folded position. The second clip is removed and allows for unfolding of the bib or towel to wipe away excess drool and saliva from the pet's or dog's mouth or to engage in other grooming related activities or functions.

In yet another embodiment, each bib or towel has a length ranging from about 10 inches to about 20 inches.

In yet another embodiment, each bib or towel is made from one of terry, cotton, cellulosic material, nylon, or combinations thereof.

In yet another embodiment, the width of both the lateral sides is equal.

In yet another embodiment, any one of the bibs or towels is used at a time for wiping away saliva or performing any other needed grooming or care for the pet.

In yet another embodiment, a grooming bib or towel system is disclosed. The bib or towel grooming system includes one or more of shaped towels or bibs, and each of the towels or bibs are removably secured to a first clip, such as a carabiner clip, and the first or carabiner clip goes through a hole disposed in each of the towels/bibs. The first clip is secured to a pet collar or other accessory allowing a pet, such as a dog, to wear the bib or towel system. The bib or towel has a snap button, and the other bib has a snap button receiver for securing the bib or towel in a folded or first position. The towel or bib may be used for any number of grooming activities such as wiping away saliva or otherwise cleaning around the mouth of a pet such as a dog. A bib or towel is in a second position when it is unfolded and in an extended length and used for the grooming activity such as wiping the saliva.

In yet another embodiment, a method of performing a grooming activity such as wiping away excess saliva from the mouth of a pet, such as a dog is described. The method includes the steps of initially providing a stack of bibs or towels and then either individually attaching at least one bib or towel held in a first position to a collar or other pet accessory using at least one of a first clip type or attaching the entire stack to the collar. Then unfolding the bib or towel into its second position. Then performing a grooming activity, such as wiping excess saliva away from the mouth of the pet, and finally removing the used bib or towel from the system and interchanging the used bib or towel with a new bib or towel.

In yet another embodiment, the method further comprises the step of unfolding a second bib or towel from a stack of bibs or towels for performing a grooming activity such as wiping excess saliva away.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the cloth, towel or bib system of the present invention in accordance with the disclosed architecture;

FIG. 2 illustrates a perspective view of another potential embodiment of the drool wiping bib or towel system of the present invention for pets in accordance with the disclosed architecture;

FIG. 3 illustrates a perspective view of exemplary individual fabric bibs used in the bib, cloth or towel system of the present invention and illustrated in FIG. 2 in accordance with the disclosed architecture;

FIG. 4 illustrates a perspective view of one potential embodiment of the unfolded exemplary bib, cloth or towel used in the system of various embodiments of the present invention in accordance with the disclosed architecture;

FIG. 5A is a perspective view of a dog wearing one potential embodiment of the bib or towel system of the present invention in accordance with the disclosed description; and

FIG. 5B illustrates a perspective view of one potential embodiment of a bib, towel or cloth of the bib, cloth or towel system of the present invention being used during a grooming activity, such as wiping away saliva and drool, in accordance with the disclosed specification.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a lightweight fabric bib or towel system for pets that can be easily used for performing grooming and care related activities such as cleaning and drying excess drool from around a dog's mouth. There is also a long-felt need in the art for a bib or towel system that can be firmly secured to a pet accessory such as a collar, harness, lead, leash, strap or other pet management device. Additionally, there is a long-felt need in the art for a fabric system for pets that can be readily replaceable and washed and dried in laundry machines for reuse. Moreover, there is a long-felt need in the art for a pet grooming system that uses one or more towels, cloths or other sheets of material that are safe and convenient to use. Further, there is a long-felt need in the art for pet fabric bibs that help maintain cleanliness and hygiene of the pets. Furthermore, there is a long-felt need in the art for a pet fabric grooming system that can function as an accessory for pets when not used. Finally, there is a long-felt need in the art for lightweight cloth bib system for pets that can be used for wiping up excess drool and saliva and is secured to the pet accessory such as a collar.

The present invention, in one exemplary embodiment, is a method of performing a grooming activity such as the wiping away of excess saliva. The method includes the steps of initially providing a stack or set of towels, cloths, bibs or other sheets of individual material and then attaching the set or stack to a pet accessory such as a collar, using at least one of a first type of clip. Then unfolding one of the stacks or set of bibs, towels, or clothes from a first folded position to a second unfolded position. Then performing at least, a first grooming exercise, such as the wiping of saliva from the mouth of the pet. Finally, removing the used bib, towel or cloth from the system, stack or set and unfolding a second towel, cloth, or bib to conduct a grooming activity.

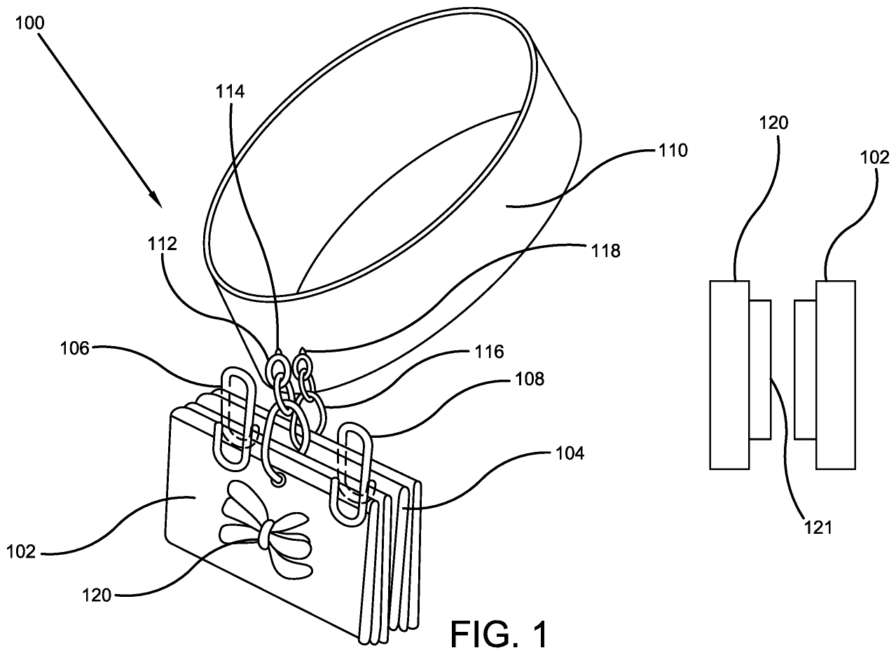

Referring initially to the drawings, FIG. 1 illustrates a perspective view of one potential embodiment of the cloth, towel, or bib system 100 of the present invention in accordance with the disclosed specification. The system 100 of the present invention is designed as a unique cloth, towel or bib system for pets, such as large dogs, allowing an individual, such as the dog owner, caretaker, pet sitter, trainer, groomer or others involved in the care or maintenance of the pet, to perform a grooming activity such as the wiping drool or saliva from the pet's mouth. The system 100 includes at least one cloth, towel or bib and preferably the system includes a stack or set of individual fabric bibs 102, 104 that are positioned in a folded or first orientation using a respective first type of clip 106, 108. The bibs 102, 104 can come in different colors, designs and sizes and are preferably rectangular in shape. The system may be sold as part of a package and may be suitable enclosed in a plastic or paper wrapping to protect the bibs 102, 104 from being inadvertently soiled prior to use.

The front bib or towel 102 and the rear bib or towel 104 are configured to be individually and separately accessed for performing the grooming activity such as wiping away saliva and drool. The front bib, towel, or cloth 102 is secured to a pet accessory, such as a collar, 110 using a first type of clip such as a carabiner clip 112 fastened to a grommet 114 in the pet accessory 110. The front bib or towel 102 can be removed from the first or carabiner clip 112 for washing and for interchanging with another bib, cloth, or towel. The rear bib or towel 104 is also secured to the dog collar 110 using a second carabiner clip 116 and fastened to a second grommet 118 in the pet accessory 110.

The towels, cloths, or bibs 102, 104 are preferably made from easy-to-clean and machine washable terry cloth and are also ideal for groomers and vets to use while grooming and treating the dogs. Other materials may be used, such as a cellulosic based material that when in a dry state has a first size and then in a wet state is a second size larger than the first size. In this way, the system 100 may be more compact making transport easier. The front towel, cloth, or bib 102 is unfolded from the first position when the clip 106 is removed and is used for conducting the grooming activity such as wiping away drool when the towel, bib or cloth is in the unfolded or second position. Once used, the front bib 102 can be folded again, returning to its original configuration, and then secured in the folded position using the clip 106. Similarly, the rear or next bib, towel or cloth 104 in the set unfolds when the clip 108 is removed and is used for conducting the grooming activity. Once used, the rear bib 104 can be folded again and secured in a folded position using the clip 108.

In one exemplary embodiment, the bibs, towels, or cloths 102, 104 have a bow design 120 positioned on the front surface thereof providing a bow tie look to the collar of a dog. The bibs, towels, or cloths 102, 104 are ideal for everyday wear, photoshoots, parties, weddings and more, in addition to being used for grooming and care activities. In some embodiments, the bibs, towels or cloths 102, 104 can be attached to any dog collar or other pet accessory using a first type of clip, such as carabiner clips, and thereby eliminating the use of a bandana or other clothes or wipes for wiping away drool and saliva. Other indicia may be provided on each of the towels, cloths, or bibs, such as the name of the pet. The indicia 120 may be applied by a removable fastener 121 such as a hook and loop system, snaps, magnets or the like so that when the first towel 102 is used, the indica can be removed and placed on the next bib or towel 104 so as not to lose use of the indicia.

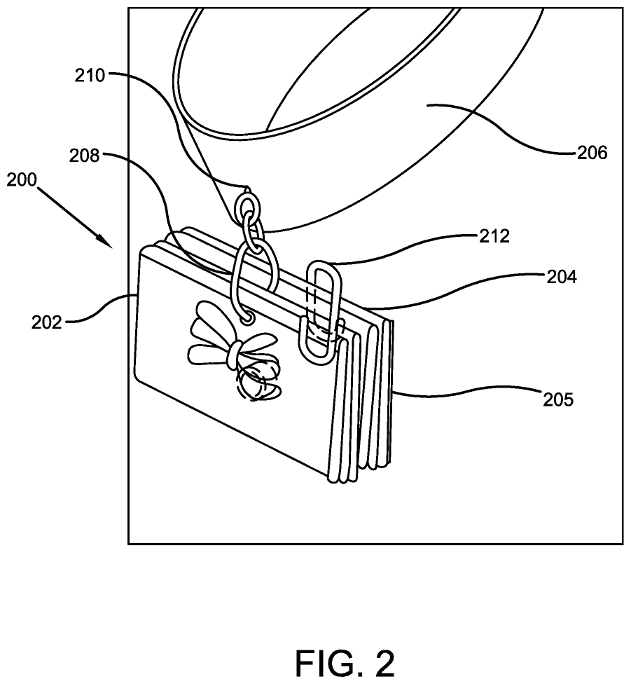

FIG. 2 illustrates a perspective view showing another potential embodiment of the grooming assist system of the present invention for pets in accordance with the disclosed specification. In the present embodiment, a pair of individual fabric bibs, towels, or cloths 202, 204 are secured to a pet accessory, such as a collar 206, using a single type of clip, such as a carabiner clip 208. The carabiner clip 208 is removably fastened to a grommet or other ring 210 disposed in the pet accessory 206.

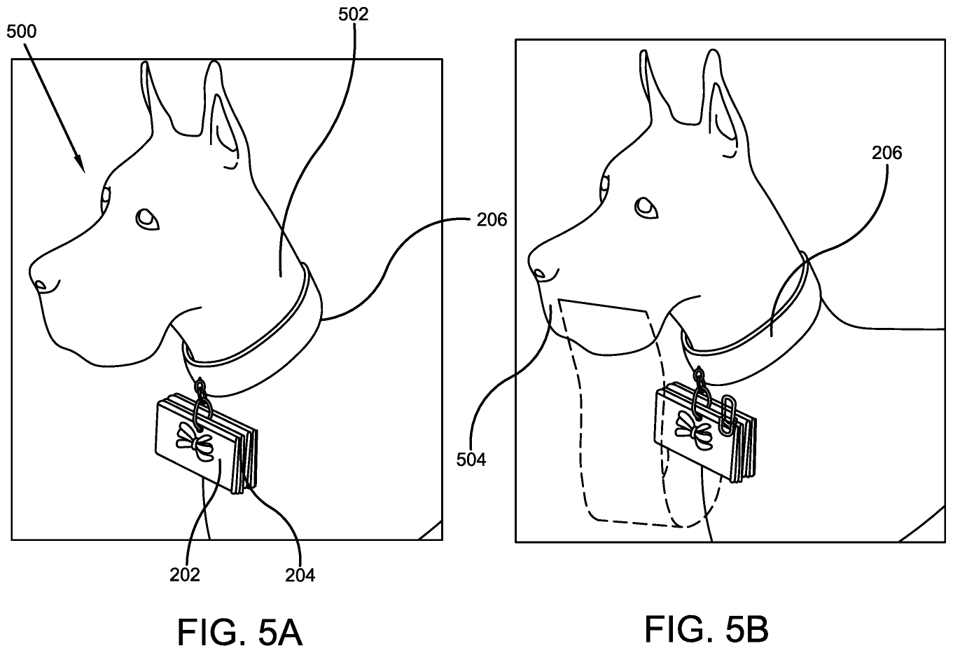

The bibs 202, 204 are folded when not used and are used as an accessory for the pet wearing the system 200. A second type of clip, such as a paper or binder clip 212, may be used for securing the individual bibs, towels, or cloths 202, 204 in a folded orientation when not in use. When needed, the clip 212 is removed to use one of the bibs, towels, or cloths 202, 204 for performing the grooming activity as illustrated in FIG. 5. The towels, cloths, or bibs may also be impregnated with essential oils to help in calming the pet when the pet is out their own environment, such as when going for a walk. Exemplary essential oils include at least one of carrot seed, cedar wood, chamomile, sage, eucalyptus, ginger, geranium, lavender, marjoram, niaouli, peppermint, sweet orange, thyme, valerian and combinations thereof. In an alternative embodiment, an insect repellant material 205 may be included with the system 200 and held at the back of the stack 200 and is removable from the stack so that it is not used in the particular grooming activity. The insect repellent material may include peppermint, basil, rosemary, lemon balm and combinations thereof.

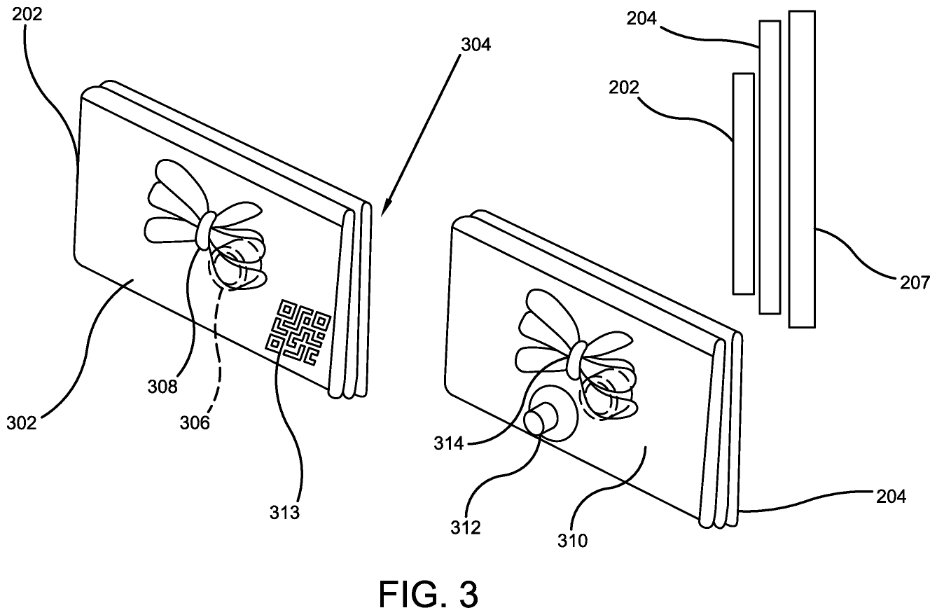

In the present embodiment, one bib of the stack or set of bibs may have a button and the another bib of the stack or set of bibs may have a slot for receiving the button to secure the bibs together in a folded orientation as illustrated in FIG. 3.

FIG. 3 illustrates a perspective view of exemplary individual fabric bibs used in the system 200 of FIG. 2 in accordance with the disclosed specification. As illustrated, the first bib, cloth, or towel 202 has a slot 306 positioned on the rear surface 304 thereof and the front surface 302 has the bow design 308 or other indicia, such as the name of the pet. When the bib 202 is secured to a pet accessory such as a dog collar, the bow design 308 is visually exposed on the front of the dog wearing the system 200.

The second bib, towel, or cloth 204 is configured to be positioned behind the first bib 202, in substantial alignment with the first bib, towel or cloth 202 and has a snap button 312 positioned on the first surface 310 near the bow design 314. The snap button 312 is configured to secure to the slot 306 for securing both the bibs 202, 204 in a folded position and the snap connection is released for using one of the bibs 202, 204 for wiping up excessive drool. The bibs, towels, or cloths of the system 200 in one embodiment, are all of the same general dimensions to form a neat package or set. In an alternative embodiment, each of the bibs, towels, or cloths 202, 204 and 207 may be of different sizes in order to accommodate different grooming activities. Also as shown in FIG. 3 a scannable element 313 is shown, which may include one of a bar code, 2D code or RFID tag. The scannable element 313 can be used to help locate the pet in the event the pet becomes displaced from the owner or other caregiver. A downloadable application can be downloaded to a smartphone or the scannable code can be scanned by a smartphone opening up a URL to help connect the pet with its owner.

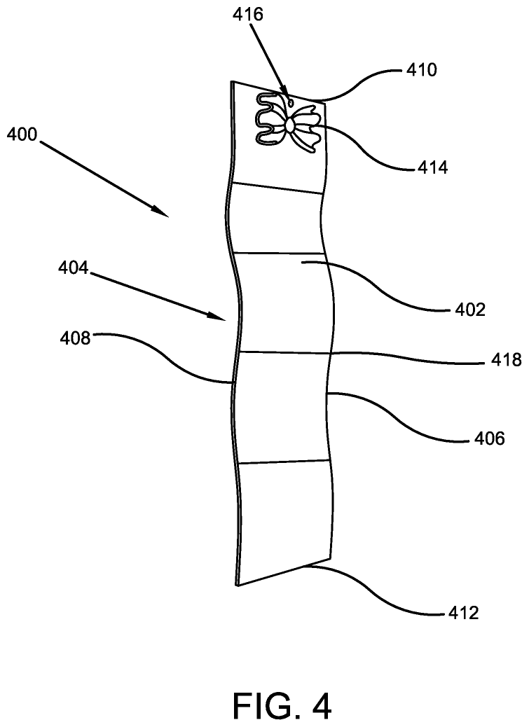

FIG. 4 illustrates a perspective view of an unfolded exemplary bib, towel, or cloth in the second position used in the bib system of various embodiments of the present invention in accordance with the disclosed specification. The exemplary bib 400 is configured to be used in different embodiments of the bib system described in the present disclosure. As illustrated, the bib 400 has a front surface 402 and a rear surface 404 formed by two longitudinal edges 406, 408 and a pair of lateral or transverse end edges 410, 412. A 2-D or 3-D bow design or other indicia 414 is disposed near the top edge 410 and a hole 416 is also disposed near the top edge 410 for receiving a first type of clip, such as carabiner clip or any other fastener. The indicia 414 may be detachable as discussed in connection with FIG. 1 and held in position by any suitable fastener.

In some embodiments, the bib may have folding lines 418 disposed laterally along length of the bib 400, at substantially equal positions along the length of the towel or bib allowing the bib to be easily folded. The folding lines 418 are provided perpendicularly to the longitudinal side edges and parallel to the transverse end edges. The bib, cloth or towel is soft, skin-friendly, free of parabens, machine-washable and lightweight.

FIG. 5A illustrates a perspective view showing a dog wearing the bib system 200 in accordance with the disclosed specification. The dog 500 wears the bib system attached to the collar 206 around the neck 502 and the pair of bibs 202, 204 are in a first or folded position allowing the bib system 200 to be used as accessory for the dog 500. It should be noted that the size and color of the bibs can vary as per the preference of dog owners and dog size. The bib system 200 is lightweight and is safe and easy to be worn by the dog 500. When the dog 500 does not drool or slobber, or the bibs, towels or cloths are not otherwise needed for other grooming related activities, the bibs remain in folded position.

FIG. 5B illustrates a perspective view showing one of bibs of the system being used for wiping away saliva in accordance with the disclosed specification. In use, when excessive drool or saliva comes from a dog's mouth who is wearing the bib system of the present invention, then, one of the bibs, preferably the front bib 202, is unfolded by removing the clip or releasing the snap button as discussed earlier in the disclosure. The length of the bib allows the bib to easily reach the mouth 504 for cleaning and drying excess drool and once the drool is cleaned, then, the unfolded bib can be folded again, can be removed from the collar 206 for washing, and can be interchanged with another bib.

Other shapes, designs and configurations of the drool wiping bib system 100, 200 are contemplated and fall within the scope of the invention without affecting the utility of the device. Since the a washable fabric is used for bibs in various embodiments, no trash is generated and also a user is not required to carry wipes or clothes for wiping away excess drool or saliva.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “drool wiping bib system”, “bib system”, “slobber cloth bib system”, “dog saliva wiping bib system” and “system” are interchangeable and refer to the dog saliva wiping bib system 100, 200 of the present invention.

Notwithstanding the foregoing, the dog saliva wiping bib system 100, 200 of the present invention can be of any suitable size and configuration as is known in the art without affecting the overall concept of the invention, provided that it accomplishes the above-stated objectives. One of ordinary skill in the art will appreciate that the dog saliva wiping bib system 100, 200 as shown in the FIGS. are for illustrative purposes only, and that many other sizes and shapes of the dog saliva wiping bib system 100, 200 are well within the scope of the present disclosure. Although the dimensions of the dog saliva wiping bib system 100, 200 are important design parameters for user convenience, the dog saliva wiping bib system 100, 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet grooming accessory comprising:
a pet grooming bib comprised of a pair of longitudinal side edges and a pair of transverse end edges;
an opening disposed in at least one of the pair of transverse end edges;
a first type of clip passing through the opening; and
a second type of clip holding the pet grooming bib in a first position such that when the second type of clip is removed the pet grooming bib is repositioned into a second position.

2. The pet grooming accessory as recited in claim 1, wherein the first position is a folded position and the second position is an unfolded position.

3. The pet grooming accessory as recited in claim 1, wherein the first type of clip is a carabiner clip.

4. The pet grooming accessory as recited in claim 1, wherein the second type of clip is a select one of a paper clip or a binder clip.

5. The pet grooming accessory as recited in claim 1, wherein the pet grooming bib is comprised of a terry cloth, a cotton, a cellulosic material, a nylon or a combination thereof.

6. The pet grooming accessory as recited in claim 5, wherein the cellulosic material has a first size in a dry state and a second size in a wet state.

7. The pet grooming accessory as recited in claim 6, wherein the first size is smaller than the second size.

8. The pet grooming accessory as recited in claim 1 further comprising a second bib.

9. The pet grooming accessory as recited in claim 1, wherein the pet grooming bib comprises an essential oil.

10. The pet grooming accessory as recited in claim 9, wherein the essential oil comprises at least one of a carrot seed, a cedar wood, a chamomile, a sage, an eucalyptus, a ginger, a geranium, a lavender, a marjoram, a niaouli, a peppermint, a sweet orange, a thyme, a valerian and a combination thereof.

11. The pet grooming accessory as recited in claim 1, wherein the pet grooming bib further comprises a design or indicia.

12. The pet grooming accessory as recited in claim 11, wherein the design or indica is removable from the pet grooming bib.

13. A reusable bib system for pets, the reusable bib system comprising:
a plurality of bibs, with each of the plurality of bibs is comprised of a pair of longitudinal side edges and a pair of transverse end edges, wherein at least two of the plurality of bibs are removably connected to one another;
at least one opening in each of the plurality of bibs for connecting each of the plurality of bibs to a pet accessory;
a first clip for connecting the pet accessory; and
a second clip, wherein the second clip is a different clip type than the first clip, and further wherein the second clip holds each of the plurality of bibs in a first position.

14. The reusable bib system for pets as recited in claim 13, wherein the pet accessory is one of a collar, a harness, a lead, a leash, a strap or a pet management device.

15. The reusable bib system for pets as recited in claim 13, wherein the at least two of the plurality of bibs are in substantial alignment with one another.

16. The reusable bib system for pets as recited in claim 13, wherein each of the plurality of bibs comprise a folding line.

17. The reusable bib system for pets as recited in claim 16, wherein the folding line is provided perpendicular to the pair of longitudinal side edges and parallel to the pair of transverse end edges.

18. The reusable bib system for pets as recited in claim 13 further comprising an insect repellent.

19. A combination collar and grooming accessory comprising:
a collar having at least one opening;
a grooming accessory comprised of at least two towels for performing a grooming activity, wherein each of the at least two towels has a first folded position and further wherein the at least two towels are connected to one another; and
a clip that attaches each of the at least two towels to the collar via the at least one opening, wherein each of the at least two towels is held in the folded position by the clip.

20. The combination collar and grooming accessory as recited in claim 19, wherein the at least two towels are held in substantial alignment with one another, and further wherein at least one of the two towels comprises a design or indicia.
